(19) United States
(12) Patent Application Publication
(10) Pub. No.: US 2025/0167341 A1
(43) Pub. Date: May 22, 2025

(54) BATTERY SYSTEM FOR VEHICLE

(71) Applicants: Hyundai Motor Company, Seoul (KR); Kia Corporation, Seoul (KR)

(72) Inventor: Do Han KIM, Yongin-Si (KR)

(73) Assignees: Hyundai Motor Company, Seoul (KR); Kia Corporation, Seoul (KR)

(21) Appl. No.: 18/651,222

(22) Filed: Apr. 30, 2024

(30) Foreign Application Priority Data
Nov. 22, 2023 (KR) 10-2023-0163487

(51) Int. Cl. H01M 10/6556; H01M 10/613; H01M 10/6551; H01M 50/249; H01M 50/262; H01M 50/271

(52) U.S. Cl. CPC H01M 10/6556; H01M 10/613; H01M 10/6551; H01M 50/262; H01M 50/271; H01M 50/249

(57) ABSTRACT

A battery system for a vehicle, includes a battery casing accommodating a battery module therein; an opening formed on a bottom portion of the battery casing and exposing a bottom surface of the battery module to an outside of the battery casing; and a cooling block sealing the opening while forming a heat conductible state with the bottom surface of the battery module.

### CROSS REFERENCE TO RELATED APPLICATION

The present application claims priority to Korean Patent Application No. 10-2023-0163487, filed Nov. 22, 2023, the entire contents of which is incorporated herein for all purposes by this reference.

### BACKGROUND OF THE PRESENT DISCLOSURE

### Field of the Present Disclosure

The present disclosure relates to a battery system mounted to a vehicle.

### Description of Related Art

A hybrid or electric vehicle is mounted with a battery system to supply power to a motor that drives the vehicle.

The battery system includes a battery module with a plurality of battery cells, and a battery casing for enclosing the battery module, a cooler for cooling the battery cells of the battery module, etc.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to improving the accuracy of the rear side collision warning by distinguishing a fixed object such as a guard rail positioned on the side of the vehicle from a moving object such as a vehicle traveling in the rear of the vehicle.

According to an exemplary embodiment of the present disclosure, a battery system for a vehicle includes: a battery casing accommodating a battery module therein; an opening formed on a bottom portion of the battery casing and exposing a bottom surface of the battery module to an outside of the battery casing; and a cooling block mounted in a lower portion of the opening and forming a heat conductible state with the bottom surface of the battery module.

The battery casing may include: a lower casing opened upwards to accommodate the battery module downwards therein from above, and formed to enclose a lower side of the battery module while forming the opening on the bottom thereof; and an upper casing coupled to a top portion of the lower casing to seal an upper side of the battery module.

The battery module may include: a plurality of battery cells overlapping each other; and a plurality of cooing fins located between the battery cells and formed to exchange heat with the battery cells and exchange heat with the cooling block.

The cooling fin may include: a cell contact portion shaped like a flat plate to be in surface-contact with the battery cells and inserted between the battery cells; and a block contact portion extending downwards from the cell contact portion and formed to be in contact with a top surface of the cooling block.

The battery system may further include a thermal interface material (TIM) pad mounted between the cooling block and the block contact portion of the cooling fin.

The battery system may further include a sealing member provided in an overlapping portion between the opening of the lower casing and the cooling block.

The cooling block may be shaped like a flat plate to seal the opening of the lower casing, and include a cooling channel through which a refrigerant circulates; and a plurality of fastening bolts may be fastened to an outward portion of the cooling block while pressing the cooling block against the lower casing with the sealing member therebetween.

The sealing member may include a cure in place gasket (CIPG) applied to at least one of the lower casing and the cooling block.

The sealing member may include a sealing gasket interposed and pressed between the lower casing and the cooling block.

The battery module may include a cartridge in which the plurality of battery cells and the plurality of cooling fins are stably maintained in an overlapping state; the cooling block may include a fastening portion positioned in a portion where the cooling channels are not present; and a through bolt may pass through the fastening portion of the cooling block and be fastened to the cartridge of the battery module.

According to an exemplary embodiment of the present disclosure, a battery system for a vehicle may include: a battery casing; a cooling block provided on one side of the battery casing; and a battery module includes a plurality of battery cells and a plurality of cooling fins, which are overlapping, and provided penetrating the battery casing and exchanging heat with the cooling block.

The battery casing may include: a lower casing opened upwards to accommodate the battery module downwards therein from above, and having a bottom surface to couple with the cooling block; and an upper casing coupled to a top portion of the lower casing to enclose an upper side of the battery module accommodated in the lower casing.

The lower casing may include an opening opened so that the cooling fins of the battery module may be in contact with the cooling block; and the cooling block is mounted in a lower portion of the opening of the lower casing.

The cooling fin may include a cell contact portion inserted between the battery cells; and a block contact portion extending downwards from the cell contact portion and formed to be in contact with a top surface of the cooling block more widely than the cell contact portion.

The battery system may further include a thermal interface material (TIM) pad mounted between the cooling fin and the cooling block.

An outward portion of the cooling block may be pressed against the lower casing by a plurality of fastening bolts; and a sealing member may be provided between the outward portion of the cooling block and the lower casing.

The battery module may include a cartridge in which the plurality of battery cells and the plurality of cooling fins are inserted; the cooling block may include at least one fastening portion; and a through bolt to be fastened to the cartridge passes through and couples with the fastening portion of the cooling block.

According to an exemplary embodiment of the present disclosure, the battery cells of the battery module accommodated in the battery casing are more effectively cooled, the battery casing and the cooling block are easily manufactured, and maintenance is improved.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a battery system for a vehicle according to an exemplary embodiment of the present disclosure,

FIG. 2 illustrates that a cooling block is separated from the battery system of FIG. 1,

FIG. 3 is a cross-sectional view taken along line III-III of FIG. 1,

FIG. 4 is a cross-sectional view taken along line IV-IV of FIG. 1,

FIG. 5 is a cross-sectional view taken along line V-V of FIG. 3,

FIG. 6 illustrates a cure in place gasket (CIPG) applied to an opening of a lower casing of FIG. 2, and

FIG. 7 illustrates a sealing gasket provided in the opening of the lower casing of FIG. 2.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, in which the same or similar elements are denoted by the same reference numerals even though they are depicted in different drawings and redundant descriptions thereof will be avoided.

Suffixes “module” and “unit” put after components in the following description are provided in consideration of only ease of description and do not have meaning or functions discriminated from each other.

In terms of describing the exemplary embodiments of the present disclosure, detailed descriptions of related art will be omitted when they may make the subject matter of the exemplary embodiments of the present disclosure rather unclear. Furthermore, the accompanying drawings are provided only for a better understanding of the exemplary embodiments of the present disclosure and are not intended to limit technical ideas of the present disclosure. Therefore, it should be understood that the accompanying drawings include all modifications, equivalents and substitutions within the scope and spirit of the present disclosure.

Terms such as “first” and “second” may be used to describe various components, but the components should not be limited by the above terms. Furthermore, the above terms are used only for distinguishing one component from another.

When it is described that one component is “connected” or “joined” to another component, it should be understood that the one component may be directly connected or joined to another component, but additional components may be present therebetween. However, when one component is referred to as being “directly connected,” or “directly coupled” to another component, it should be understood that additional components may be absent between the one component and another component.

Unless the context clearly dictates otherwise, singular forms include plural forms as well.

In an exemplary embodiment of the present disclosure, it should be understood that term “include” or “have” indicates that a feature, a number, a step, an operation, an element, a part, or the combination thereof described in the exemplary embodiments is present, but does not preclude a possibility of presence or addition of one or more other features, numbers, steps, operations, elements, parts or combinations thereof, in advance.

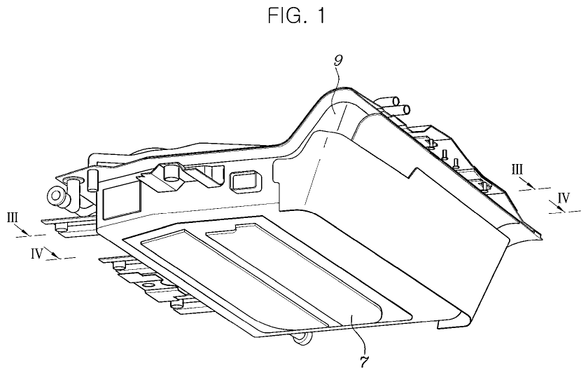

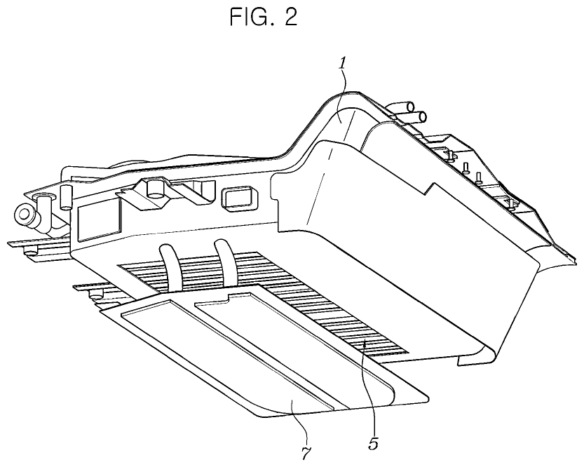

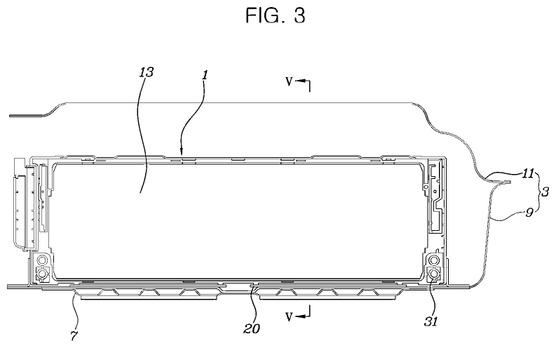

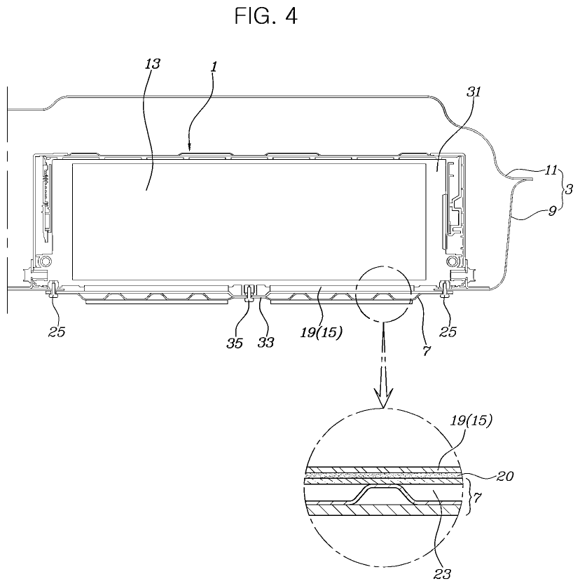

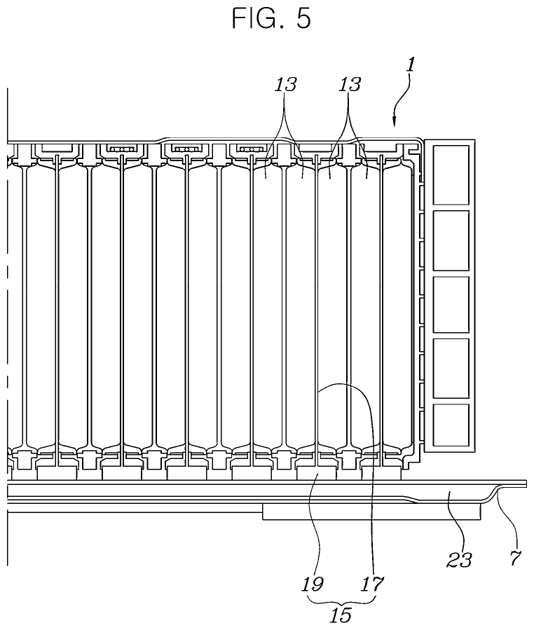

Referring to FIG. 1 to FIG. 7, a battery system for a vehicle according to an exemplary embodiment of the present disclosure includes a battery casing 3 accommodating a battery module 1 therein; an opening 5 formed on the bottom portion of the battery casing 3 and exposing the bottom surface of the battery module 1 therethrough; and a cooling block 7 disposed in a lower portion of the opening 5 while forming a heat conductible state with the bottom surface of the battery module 1.

In other words, the battery system according to an exemplary embodiment of the present disclosure includes the cooling block 7 configured to cool the bottom surface of the battery module 1 accommodated in the battery casing 3, in which the cooling block 7 is provided as an additional part separated from and mounted to the battery casing 3 and mounted to the battery casing 3, and the battery casing 3 is formed with the opening 5 for heat conduction between the cooling block 7 and the battery module 1.

Therefore, the battery casing 3 does not separately include a built-in cooler for cooling the battery module 1, but includes the cooling block 7 mounted to the exterior of the battery casing 3 to cool the battery module 1 accommodated therein.

With the present configuration, the battery casing 3 and the cooling block 7 are easily manufactured, and improved maintenance of the cooling block 7 or the like is ensured.

The battery casing 3 includes a lower casing 9 opened upwards to accommodate the battery module 1 downwards therein from above, and formed to enclose a lower side of the battery module 1 while having the opening 5 formed on the bottom thereof; and an upper casing 11 coupled to the top portion of the lower casing 9 to seal the upper side of the battery module 1.

Therefore, the lower casing 9 is manufactured having a simple shape sized enough to accommodate the battery module 1 therein, and including the opening 5 formed on the bottom surface thereof, having an effect on reducing the weight. Furthermore, the watertightness of the battery casing 3 is ensured when the opening 5 is properly sealed by the cooling block 7.

The battery module 1 includes a plurality of battery cells 13 overlapping each other; and a plurality of cooing fins 15 located between the battery cells 13 and formed to exchange heat with the battery cells 13 and exchange heat with the cooling block 7.

The cooling fin 15 includes a cell contact portion 17 shaped like a flat plate to be in surface-contact with the battery cells 13 and inserted between the battery cells 13; and a block contact portion 19 extending downwards from the cell contact portion 17 and formed to be in contact with the top surface of the cooling block 7.

Therefore, the cell contact portion 17 of the cooling fin 15 effectively absorbs heat generated from the battery cells 13 and transfers heat to the block contact portion 19, and the block contact portion 19 exchanges heat with the cooling block 7, ultimately achieving effective cooling for the battery cells 13.

A thermal interface material (TIM) pad 20 may be located between the cooling block 7 and the block contact portion 19 of the cooling fin 15.

Accordingly, a more efficient heat conductible state is formed without a fine gap between the cooling block 7 and the block contact portion 19, having an excellent effect on cooling the battery cells 13.

A sealing member 21 is provided in an overlapping portion between the opening 5 of the lower casing 9 and the cooling block 7.

Furthermore, the cooling block 7 is shaped like a flat plate to seal the opening 5 of the lower casing 9, and includes a cooling channel 23 through which a refrigerant circulates; and a plurality of fastening bolts 25 is fastened to an outward portion of the cooling block 7 while pressing the cooling block 7 against the lower casing 9 with the sealing member 21 therebetween.

Therefore, the cooling block 7 is pressed against the lower casing 9 with the sealing member 21 therebetween by the fastening bolts 25 to seal the opening 5 of the lower casing 9 in a completely watertight state, and is in close contact with the cooling fins 15 of the battery module 1 to ensure high thermal conductivity.

The sealing member 21 may include a cure in place gasket (CIPG) 27 applied to at least one of the lower casing 9 and the cooling block 7.

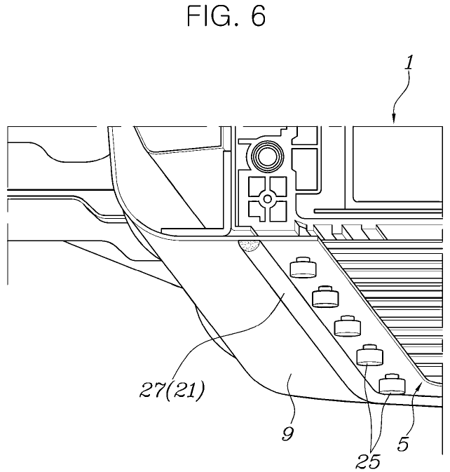

For reference, FIG. 6 illustrates that the CIPG 27 is applied to the lower casing 9.

Furthermore, the sealing member 21 may include a separate sealing gasket 29 made of rubber, silicone, or the like and interposed and pressed between the lower casing 9 and the cooling block 7.

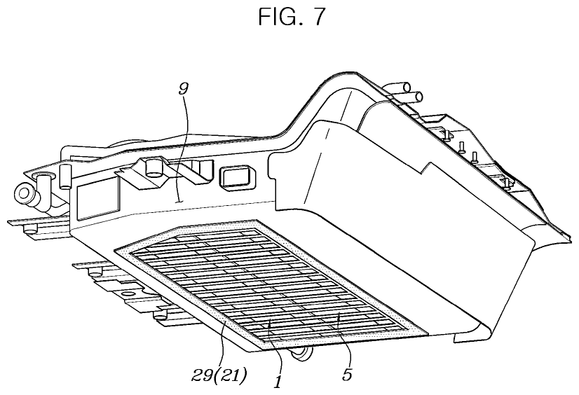

FIG. 7 illustrates that the sealing gasket 29 is in close contact with the periphery of the opening 5 of the lower casing 9, in which the cooling block 7 is not shown.

Meanwhile, the battery module 1 includes a cartridge 31 in which the plurality of battery cells 13 and the plurality of cooling fins 15 are stably maintained in an overlapping state; the cooling block 7 includes a fastening portion 33 positioned in a portion where the cooling channels 23 are not present; and a through bolt 35 passes through the fastening portion 33 of the cooling block 7 and is fastened to the cartridge 31 of the battery module 1.

Therefore, close contact between the cooling block 7 and the cooling fins 15 of the battery module 1 is stably ensured while preventing a center portion of the cooling block 7 from sagging.

For reference, the refrigerant circulates through the cooling channel 23 of the cooling block 7, effectively discharging heat transferred from the battery module 1 to the outside thereof.

According to an exemplary embodiment of the present disclosure, the battery system configured as described above may be mounted to the bottom portion of the vehicle, and thus has an effect on cooling the battery casing 3 and the cooling block 7 with winds caused by the running of the vehicle, further enhancing the efficiency of cooling the battery module 1.

The present disclosure described above may also expressed as follows.

In other words, a battery system for a vehicle according to an exemplary embodiment of the present disclosure includes a battery casing 3; a cooling block 7 provided on one side of the battery casing 3; and a battery module 1 including a plurality of battery cells 13 and a plurality of cooling fins 15, which are overlapping, and provided for penetrating the battery casing 3 and exchanging heat with the cooling block 7.

The battery casing 3 may include a lower casing 9 opened upwards to accommodate the battery module 1 downwards therein from above, and including a bottom surface to couple with the cooling block 7; and an upper casing 11 coupled to the top portion of the lower casing 9 to enclose an upper side of the battery module 1 accommodated in the lower casing 9.

The lower casing 9 may include an opening 5 opened so that the cooling fins 15 of the battery module 1 may be in contact with the cooling block 7; and the cooling block 7 may be coupled to seal the opening 5 of the lower casing 9.

The cooling fin 15 may include a cell contact portion 17 inserted between the battery cells 13; and a block contact portion 19 extending downwards from the cell contact portion 17 and formed to be in contact with the top surface of the cooling block 7 more widely than the cell contact portion 17.

A thermal interface material (TIM) pad 20 may be located between the cooling fin 15 and the cooling block 7.

An outward portion of the cooling block 7 may be pressed against the lower casing 9 by a plurality of fastening bolts 25; and a sealing member 21 may be provided between the outward portion of the cooling block 7 and the lower casing 9.

The battery module 1 may include a cartridge 31 in which the plurality of battery cells 13 and the plurality of cooling fins 15 are inserted; the cooling block 7 may include at least one fastening portion 33; and a through bolt 35 to be fastened to the cartridge 31 may pass through and couple with the fastening portion 33 of the cooling block 7.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery system for a vehicle, the battery system comprising:
a battery casing accommodating a battery module therein;
an opening formed on a bottom portion of the battery casing and exposing a bottom surface of the battery module to an outside of the battery casing; and
a cooling block mounted in a lower portion of the opening and forming a heat conductible state with the bottom surface of the battery module.

2. The battery system of claim 1, wherein the battery casing includes:
a lower casing including the opening opened upwards to accommodate the battery module downwards therein from above, and formed to enclose a lower side of the battery module; and
an upper casing coupled to a top portion of the lower casing to seal an upper side of the battery module.

3. The battery system of claim 1, wherein the battery module includes:
a plurality of battery cells overlapping each other; and
a plurality of cooing fins located between the battery cells and formed to exchange heat with the battery cells and exchange heat with the cooling block.

4. The battery system of claim 3, wherein each cooling fin includes:
a cell contact portion shaped of a flat plate, being in surface-contact with the battery cells and inserted between the battery cells; and
a block contact portion extending downwards from the cell contact portion and formed to be in contact with a top surface of the cooling block.

5. The battery system of claim 4, further including a thermal interface material (TIM) pad mounted between the cooling block and the block contact portion of each cooling fin.

6. The battery system of claim 2, further including a sealing member provided in an overlapping portion between the opening of the lower casing and the cooling block.

7. The battery system of claim 6,
wherein the cooling block is shaped of a flat plate to seal the opening of the lower casing, and includes at least one cooling channel through which a refrigerant circulates, and
wherein a plurality of fastening bolts is fastened to an outward portion of the cooling block in a state of pressing the cooling block against the lower casing with the sealing member therebetween.

8. The battery system of claim 7, wherein the sealing member includes a cure in place gasket (CIPG) applied to at least one of the lower casing and the cooling block.

9. The battery system of claim 7, wherein the sealing member includes a sealing gasket interposed and pressed between the lower casing and the cooling block.

10. The battery system of claim 7,
wherein the battery module includes a cartridge in which the plurality of battery cells and the plurality of cooling fins are maintained in an overlapping state,
wherein the cooling block includes a fastening portion positioned in a portion where the at least one cooling channel is not present, and
wherein a through bolt passes through the fastening portion of the cooling block and is fastened to the cartridge of the battery module.

11. The battery system of claim 10, wherein the fastening portion is located in a center portion of the cooling block.

12. A battery system for a vehicle, the battery system comprising:
a battery casing;
a cooling block provided on one side of the battery casing; and
a battery module includes a plurality of battery cells and a plurality of cooling fins, which are overlapping, and penetrating the battery casing and exchanging heat with the cooling block.

13. The battery system of claim 12, wherein the battery casing includes:
a lower casing opened upwards to accommodate the battery module downwards therein from above, and including a bottom surface to couple with the cooling block; and
an upper casing coupled to a top portion of the lower casing to enclose an upper side of the battery module accommodated in the lower casing.

14. The battery system of claim 13,
wherein the lower casing includes an opening opened so that the cooling fins of the battery module are in contact with the cooling block through the opening, and
wherein the cooling block is mounted in a lower portion of the opening of the lower casing.

15. The battery system of claim 14, wherein each cooling fin includes:
a cell contact portion inserted between the battery cells; and
a block contact portion extending downwards from the cell contact portion and formed to be in contact with a top surface of the cooling block more widely than the cell contact portion.

16. The battery system of claim 14, further including a thermal interface material (TIM) pad mounted between the cooling fins and the cooling block.

17. The battery system of claim 14,
wherein an outward portion of the cooling block is pressed against the lower casing by a plurality of fastening bolts, and
wherein a sealing member is provided between the outward portion of the cooling block and the lower casing.

18. The battery system of claim 17,
wherein the battery module includes a cartridge in which the plurality of battery cells and the plurality of cooling fins are inserted,
wherein the cooling block includes at least one fastening portion, and
wherein a through bolt to be fastened to the cartridge passes through and couples with the at least one fastening portion of the cooling block.

19. The battery system of claim 17,
wherein the at least one fastening portion is positioned in a portion where the at least one cooling channel is not present, and
wherein the at least one fastening portion is further located in a center portion of the cooling block.
